(19) United States
(12) Patent Application Publication
(10) Pub. No.: US 2007/0258368 A1
(43) Pub. Date: Nov. 8, 2007

(54) Network device user control interface

(75) Inventors: James W. Dickerson, Plano, TX (US); Mark C. Cromwell, Plano, TX (US); Dennis K. Smith, Plano, TX (US)

Correspondence Address: BAKER & MCKENZIE LLP;PATENT DEPARTMENT, 2001 ROSS AVENUE, SUITE 2300, DALLAS, TX, 75201, US

(73) Assignee: AGILEMESH, INC., Richardson, TX (US)

(21) Appl. No.: 11/744,768

(22) Filed: May 4, 2007

Related U.S. Application Data
(60) Provisional application No. 60/746,577, filed on May 5, 2006.

(51) Int. Cl. H04L 12/26; H04L 12/56

(52) U.S. Cl. 370/230; 370/389

(57) ABSTRACT

Disclosed herein are user interfaces for configuring network devices for wired and wireless networks and methods thereof. The network device is configured via a user interface with a communications channel selector and a node selector, where each channel is associated with a predetermined parameter, and each node is associated with an internet protocol address.

### CROSS REFERENCE TO RELATED APPLICATIONS

This application claims the benefit of U.S. Provisional Application Ser. No. 60/746,577, filed on May 5, 2006, and entitled “Network device user control interface,” which is commonly assigned with the present application and incorporated herein by reference.

### BACKGROUND

1. Technical Field

Disclosed embodiments relate generally to data networking, and more specifically relate to configuring a network device for a data network.

2. Description of Related Art

In known data networks, installation of network devices generally involves configuration of a number of parameters on a number of devices. With the increasing variety of network devices currently available, setup of these devices to provide a secure, working network has become increasingly complex.

For example, installation of a network in a corporate environment involves configuration of a number of parameters on firewalls, routers, wireless access points, servers, printers and on each user's computer. In the case of some of these devices, such as wired and wireless routers, wireless access points and user computers, there are usually multiple instances of each one. Generally, they should all be configured to work with each other or the network is viewed as non-working. As a result, setting up a network that includes multiple network devices is often time-consuming, expensive and frustrating for the users and requires the application of specially trained professionals to accomplish. In addition, delays associated with these sorts of setups often result in substantial loss of worker productivity.

Another exemplary example is the case of an installation based on an 802.11 network. Setup requirements include the channel number (typically, the selection of the center frequency on which the device will communicate), the SSID, the encryption key or keys and the Internet Protocol address of the LAN side of the device. For several of these parameters, each device on the network needs to be communicated with and configured individually. In addition, it is not unusual for an address or encryption code to be incorrectly assigned, thus rendering a device inaccessible from the network. Corrections of these types of errors are often difficult and time consuming, particularly since many users of data networks may not have a strong understanding of the workings and considerations associated with data networks.

### BRIEF SUMMARY

Described herein are network devices for data networks that substantially meet these needs and others. In various embodiments, the network devices may be wired or wireless network devices.

In an embodiment, provided is a user interface for a network device. The user interface includes a communications channel selector and a node selector. The communications channel selector is for selecting a communications channel that is associated with predetermined parameters, and the node selector is for selecting a node identifier that defines an internet protocol address for the node and peripheral network devices attached to the node.

### BRIEF DESCRIPTION OF DRAWINGS

FIG. 1 is a schematic block diagram of a communications network that is in accordance with the present disclosure; and

FIG. 2 is a diagram of a user interface that may be used with a network device in accordance with the present disclosure.

### DETAILED DESCRIPTION OF THE INVENTION

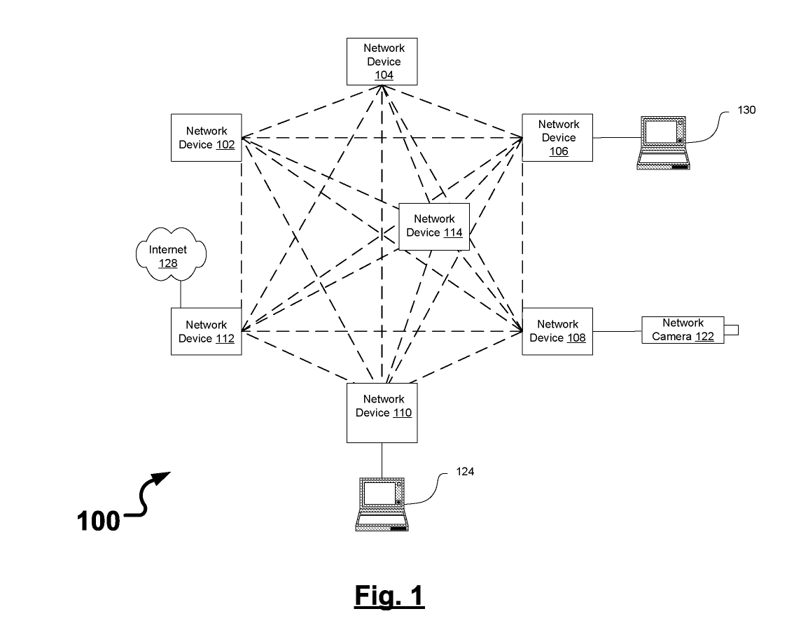

FIG. 1 is a schematic block diagram illustrating a communications network 100 that includes a plurality of network devices 102-114. The network devices 102-114 may be operably coupled to other network devices via wired or wireless network connections. As used herein, the term “network device” refers a router, wireless router, switch, bridge, modem, system controller, wireless access point, or a combination thereof, that generally may provide for data communication between and among network devices of the communications network 100. The communications network 100 may be connected to other networks, including wide area network 128, for instance, via network device 112. As an example, various networked peripherals may communicate via communications network 100, including computers 124, 130 and network camera 122.

Typically, messages sent within data packets traverse the communications network 100 by hopping from one network device to another network device until the data packets reach their destination. Usually these data packets jump between adjacent network devices, called neighbors e.g., neighboring network devices 102 and 104, network devices 108 and 110, et cetera. Generally, data network topologies provide for a generous number of interconnections among neighboring network devices throughout the network 100. FIG. 1 depicts an exemplary network, although such a plurality of interconnections is not necessary for operation.

Each network device in the communications network 100 computes a source tree (or routing table) that defines the paths to all neighboring network devices within its reach. These neighbors communicate with one another efficiently using special messages that propagate the data network. Changes in the data network are reported regularly to make the end-to-end configuration dynamic.

Link metrics may be used to maximize performance as traffic moves edge-to-edge through the data network. These metrics can be based on measuring signal strength, stability, transfer rate, bit error rate, latency, number of hops, or other ‘per link’ parameters. Each link therefore carries a ‘cost’ and the overall load can be balanced efficiently by whatever path presents the least cost.

The communications between network devices 102-114 may have self-management, self-configuring, self-tuning, self-healing and self-monitoring capabilities. A management console (e.g., running on laptop 124) may be used to provide a visualization of actual interconnections between nodes 102-114, and may also provide a means to monitor the communication network's 100 status from edge-to-edge, and provide performance and activity statistics. The console may also provide some form of command and control over the communications network 100, including network device updates, software upgrades, and reconfigurations.

Security is a major concern for data networks. Traffic within communications network 100 preferably should be secured and outside devices, including data sources and those that use the data network's Ethernet services, should be prohibited from accessing internal data network traffic. Features like digital signatures can be used to ensure that only authorized systems participate in the wireless network. User traffic between nodes can also be encrypted to prevent eavesdropping, for instance, by using 128-bit and 256-bit AES encryption, WEP, or the like. The communications network 100 may also support other security standards available on other Ethernet-based and wireless networks. Compatibility with any end-to-end security provisions, such as virtual private networks (VPNs), may also be implemented for securing over-the-air communications between network devices.

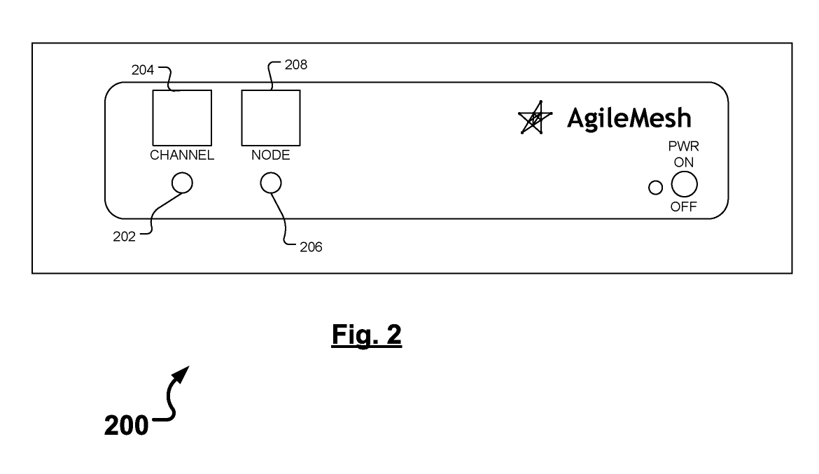

FIG. 2 is a diagram of a user interface 200 that may be used on or with a network device. Fielding a communications network 100 requires configuration of a number of parameters, for example, in the case of a wireless network device, selection of the center frequency on which the device will communicate, the Internet Protocol address, and in some instances an encryption key. In another example, for a wired network device, parameters that may be selectable include router protocols such as, but not limited to, Open Shortest Path First (OSPF), Interior Gateway Routing Protocol (IGRP), Border Gateway Protocol (BGP), IPv6, VPN tunnels, VLANs, RIP, Multicast, MPLS and so on. Additional or alternative parameters that may be selected that are associated with router protocols include Maximum Transmission Unit (MTU) size, optical channelization, transmission clocking source, clocking synchronization method, virtual private networking identifiers and encryption keys, and various timing interval parameters. It should be apparent to a person of ordinary skill in the art that this is not an exclusive list of parameters, and that others may be used.

In setting up a communications network with known network devices, each network device of the network needs to be communicated with and the parameters configured individually. In addition, it is not unusual for an address or encryption code to be incorrectly assigned, thus rendering a network device completely inaccessible from the network. Correction of these types of errors are often difficult and laborious. Since many potential users of a communications network may not have a strong understanding of data networks for the setup of network devices, it is desirable to have a simple setup process catering for such users.

Accordingly, user interface 200 provides users of network devices with an exemplary interface that configures network parameters based on user selection of virtual “channels”. Accordingly, user interface 200 includes a channel selector 202, a channel indicator 204, a node selector 206, a node indicator 208. Channel selector 202 and node selector 206 may be push button, toggle, or rotatable switches that are used to select the channel and node respectively. Channel and node selection may also or alternatively be performed via a remote device, e.g., RF or infrared remote control, or over the communications network via a client or browser-based interface (not shown). Channel indicator 204 represents a communications “channel,” and node indicator 208 represents the node address of the network device 102, which may be displayed on a digital display e.g., using mechanical digits, liquid crystal digits, LED, LCD/TFT panel displays, et cetera.

In an embodiment of a wireless network device, in selecting a channel via channel selector 202, the wireless network device with which the user interface 200 is associated may select a combination of a particular frequency channel and, in some instances, one of several predetermined encryption keys, and a Service Set Identifier (SSID). The node indicator 408 shows a number that is associated with a network address of the network device according to a predetermined mapping. Table 1 provides an exemplary mapping of selected “channels” to map to frequencies, encryption keys, SSIDs (not shown) and network (most likely Internet Protocol) addresses. Note that other mapping schemes are possible and likely to be used for different implementations of the network device.

In the below example, for a wireless node, communication channels may map to 802.11 frequency channels, SSIDs and pre-configured encryption keys. The following list illustrates an exemplary mapping of channel numbers:
00 to 10 maps to 802.11 wireless channels 1-11, unencrypted, SSID1;
11 to 21 map to 802.11 channels 1-11, encryption key 1, SSID 1;
22 to 32 map to 802.11 channels 1-11, encryption key 2, SSID1;
33 to 43 map to 802.11 channels 1-11, encryption key 3, SSID2;
44 to 54 map to 802.11 channels 1-11, encryption key 4, SSID2;
55 to 65 map to 802.11 channels 1-11, encryption key 5, SSID3; and
66 to 99 are reserved for diagnostic use.

Node identifiers map to IP addresses. Node identifier number is an offset to be added to pre-configured base IP address. It should be noted that this exemplary mapping is shown for IEEE 802.11b/g US product. The mapping may be different for other countries or standards.

### A node identifier mapping example is shown below.

00 to 63 map to Base IP address+node identifier number; and
64 to 99 are reserved for diagnostic use

The set of predetermined encryption keys and the base IP address may be configurable via an embedded web-server interface that can be accessed across the network from a computer with a web browser.

With this type of user interface 200, a user that is unfamiliar with network device configuration can simply select the desired virtual communications “channel” and the node identifier to which the associated video input is assigned. Each node on the same channel should have a unique node identifier.

A similar user interface 200 may be represented on a remote computer-based graphical control panel (i.e., a client, web browser, et cetera). The net result is that the rather esoteric frequency channels, encryption keys and IP addresses can be assigned automatically for the user without the necessity of understanding the technical aspects of these parameters. Consequently, the non-technical user may now find the configuration and use of the data network to be much more accessible and less intimidating than was previously the case with conventional network devices. In addition, the probability of an error rendering a network device inaccessible is less likely and easily corrected if it does happen.

As one of ordinary skill in the art will appreciate, the term “operably coupled”, as may be used herein, includes direct coupling and indirect coupling via another component, element, circuit, unit, or module where, for indirect coupling, the intervening component, element, circuit, unit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”.

Having described several embodiments, it will be recognized by those of ordinary skill in the art that various modifications, alternative constructions, and equivalents may be used without departing from the spirit of the disclosed embodiments. Accordingly, the presently disclosed embodiments are therefore considered in all respects to be illustrative and not restrictive. The scope of the invention is indicated by the appended claims rather than the foregoing description, and all changes that come within the meaning and ranges of equivalents thereof are intended to be embraced therein.

Additionally, the section headings herein are provided for consistency with the suggestions under 37 C.F.R. § 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background of the Invention” is not to be construed as an admission that technology is prior art to any invention(s) in this disclosure. Neither is the “Brief Summary of the Invention” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. A user interface for a network device comprising:
a communications channel selector for selecting a communications channel, wherein the communications channel is associated with a predetermined parameter; and
a node selector for selecting a node identifier, wherein the node identifier is associated with an internet protocol address.

2. The user interface of claim 1, wherein the network device is a wireless network device, and wherein the predetermined parameter comprises at least one of a channel number, an encryption key, and a Service Set Identifier (SSID).

3. The user interface of claim 1, wherein the network device is a wired network device, and wherein the predetermined parameter comprises a router protocol.

4. The user interface of claim 1, wherein the communications channel selector comprises one of a push button, toggle and a rotatable switch.

5. The user interface of claim 1, wherein the predetermined parameter comprises a channel number associated with an IEEE 802.11 standard frequency.

6. The user interface of claim 1, further comprising a display for representing a communications channel selection and a node identification selection.

7. The user interface of claim 1, further comprising a look up table for storing at least one predetermined parameter associated with each communications channel.

8. The user interface of claim 7, wherein the at least one predetermined parameter is configurable over a network connection.

9. A user interface for a network device comprising:
a communications channel selector for selecting a communications channel, wherein the communications channel is associated with a channel number, an encryption key, and a Service Set Identifier (SSID); and
a node selector for selecting a node identifier, wherein the node identifier is associated with an internet protocol address.

10. The user interface of claim 9, wherein the communications channel selector comprises one of a push button, toggle and a rotatable switch.

11. The user interface of claim 9, wherein the channel number is associated with an IEEE 902.11 standard frequency.

12. The user interface of claim 9, further comprising a display for representing a communications channel selection and a node identification selection.

13. The user interface of claim 9, further comprising a look up table for storing at least one of the channel number, SSID, and encryption key, associated with each communications channel.

14. The user interface of claim 13, wherein the SSID and encryption key is configurable over a network connection.

15. A method to configure a network device comprising:
selecting a communications channel on a communications channel selector, wherein the communications channel is associated with a predetermined parameter; and
selecting a node identifier on a node selector, wherein the node identifier is associated with an internet protocol address.

16. The method of claim 15, wherein the predetermined parameter comprises at least one of a channel number, an encryption key, and a Service Set Identifier (SSID).

17. The method of claim 15, wherein the communications channel selector comprises one of a push button, toggle and a rotatable switch.

18. The method of claim 15, further comprising displaying a representation of a communications channel selection and a node identification selection.

19. The method of claim 15, further comprising storing in a look up table at least one of the channel number, SSID, and encryption key, associated with each communications channel.

20. The method of claim 19, further comprising configuring over a network connection at least one of the channel number, SSID, and encryption key.
